(19) United States
(12) Patent Application Publication
(10) Pub. No.: US 2010/0251221 A1
(43) Pub. Date: Sep. 30, 2010

(54) COMBINATION MAY-MUST CODE ANALYSIS

(75) Inventors: Aditya V. Nori, Bangalore (IN); Patrice Godefroid, Mercer Island, WA (US); Sriram Rajamani, Bangalore (IN); Sai Deep Tetali, Bangalore (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/410,177

(22) Filed: Mar. 24, 2009

(51) Int. Cl. G06F 11/36

(52) U.S. Cl. 717/131

(57) ABSTRACT

A method of analyzing a computer application is disclosed. The method may break an application into components and the method may determine if the components have already been analyzed for errors, either through static analysis or by a code analysis. If the component has already been analyzed, the previous analysis may be used and the method may move on to the next code section. If the component has not been analyzed, it may be determined if the component may be reached from a given starting point. If the component cannot be reached from a given starting point, the component may not be analyzed. Both static and code testing tools may be used to determine if errors exist. The fined-grained coupling and alternation of may (universal) and must (existential) summaries allow the method to easily navigate through these code fragments while traditional may-only, must-only or non-compositional may-must al-gorithms are stuck in their specific analyses.

### BACKGROUND

This Background is intended to provide the basic context of this patent application and it is not intended to describe a specific problem to be solved.

Program analysis tools typically compute two types of information: (1) may information is true of all program executions and is used to prove the absence of bugs in the program, and (2) must information is true of some program executions and is used to prove the existence of bugs in the program. May and must analyses offer complementary approaches to solve this problem. A may analysis can be used to prove that all executions of the program satisfy an assertion, while a must analysis can be used to prove the existence of some program execution that violates the assertion.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A new algorithm, dubbed SMASH, computes both may and must information compositionally. At each procedure boundary, may and must information is represented and stored as may and must summaries, respectively. Those summaries are computed in a demand-driven manner and possibly using summaries of the opposite type. Compositional approaches to property checking involve decomposing the whole-program analysis into several sub-analyses of individual components (such as program blocks or procedures), summarizing the results of these sub-analyses, and memorizing (caching) those summaries for possible later re-use in other calling contexts.

SMASH performs both may analysis and must analysis simultaneously, and uses both may summaries and must summaries to improve the efficiency of the analysis. A novel feature of SMASH is its inherent use of alternation: both may analysis and must analysis in SMASH use both may summaries and must summaries. The fined-grained coupling and alternation of may (universal) and must (existential) summaries allow SMASH to easily navigate through these code fragments while traditional may-only, must-only or non-compositional may-must al-gorithms are stuck in their specific analyses.

### BRIEF DESCRIPTION OF THE DRAWINGS

FIG. 1 is an illustration of a portable computing device; and

FIG. 2 a flowchart of a method of analyzing an application for errors.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

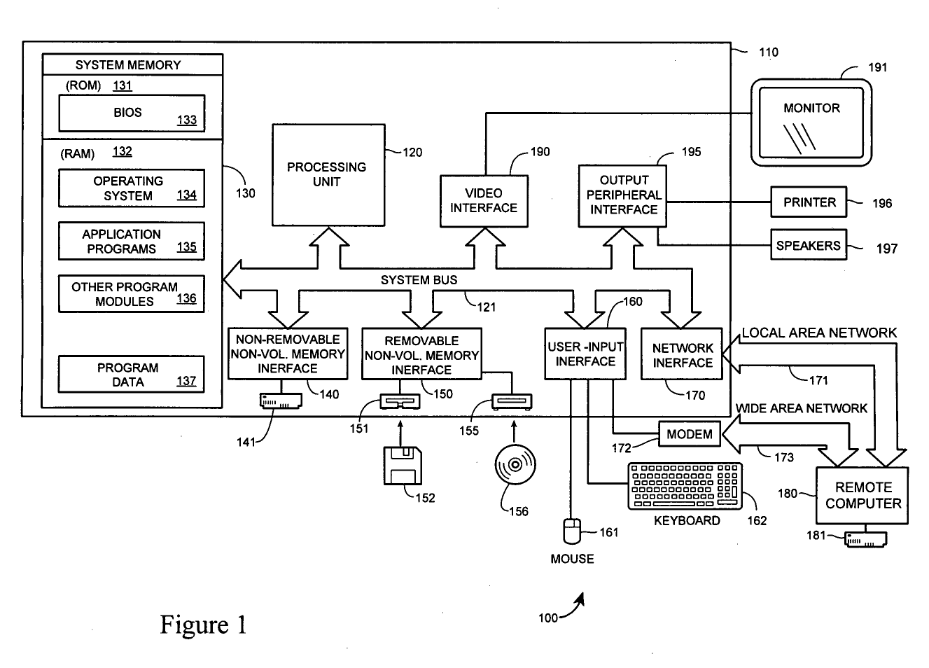

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

Introduction

In this application, a new algorithm, named SMASH is described, that performs both may analysis and must analysis simultaneously, and uses both may summaries and must summaries to improve the efficiency of the analysis. A feature of SMASH is its inherent use of alternation: Both may analysis and must analysis in SMASH use both may summaries and must summaries. The fined-grained coupling and alternation of may (universal) and must (existential) summaries allow SMASH to easily navigate through these code fragments while traditional may-only, must-only or non-compositional may-must algorithms are stuck in their specific analyses. The input to SMASH is a sequential program P and an assertion in P. The goal of SMASH is either to prove that the assertion holds for all executions of P, or to find an execution of P that violates the assertion. SMASH performs a modular interprocedural analysis and incrementally decomposes this reachability query into several sub-queries that are generated on a demand-driven manner.

Each sub-query may be of the form of

$$〈 {ϕ}_{1} {{}^{?}}_{f} {ϕ}_{2} 〉 ,$$

where φ₁ and φ₂ are state predicates representing respectively a pre-condition (calling context) and post-condition (return context) for a procedure f (or block) in P. The answer to such a query is “yes” if there exists an execution of f starting in some state σ₁∈φ₁ and terminating in some state σ₁∈φ₂, “no” if such an execution does not exist, and “unknown” (“maybe”) if the algorithm is unable to decisively conclude either way (the last option is needed since the problem is undecidable in general). SMASH uses may and must summaries to answer queries.

A may summary

$$〈 {ψ}_{1} {{}^{\text{may}}}_{f} {ψ}_{2} 〉$$

implies that, for any state x∈ψ₁, for any state y such that the execution of f starting in state x terminates in state y, there exists is y∈ψ₂. For technical convenience, SMASH maintains negated may summaries, called not-may summaries, where the post-condition is complemented. Thus, a not-may summary

$$〈 {ψ}_{1} {{}^{\text{may}}}_{f} {ψ}_{2} 〉$$

implies that for any state x∈ψ₁, there does not exist a state y∈ψ₂ such that the execution of f starting in state x terminates in state y. Clearly, a not-may summary

$$〈 {ψ}_{1} {{}^{\text{may}}}_{f} {ψ}_{2} 〉$$

can be used to give a “no” answer to a query

$$〈 {ϕ}_{1} {{}^{?}}_{f} {ϕ}_{2} 〉$$

for f provided that φ₁ [symbol] ψ₁ and φ₂ [symbol] ψ₂.

A must summary

$$〈 {ψ}_{1} {{}^{\text{must}}}_{f} {ψ}_{2} 〉$$

implies that, for every state y∈ψ₂, there exists a state x∈ψ₁ such that the execution of f starting in state x∈φ₁ terminates in state y∈φ₂ (this is also called must). Thus, a must summary

$$〈 {ψ}_{1} {{}^{\text{must}}}_{f} {ψ}_{2} 〉$$

can be used to give a “yes” answer to a query

$$〈 {ϕ}_{1} {{}^{?}}_{f} {ϕ}_{2} 〉$$

provided that ψ₁ [symbol] φ₁ and ψ₂∩φ₂≠{ }

SMASH computes not-may summaries on abstract state sets, called regions, using predicate abstraction and automatic partition refinement, and it computes must summaries using symbolic execution along specific whole-program paths. SMASH starts with an empty set of summaries for each function. As the SMASH algorithm proceeds, it progressively refines the not-may summaries and must summaries of each function on demand, in order to prove that the assertion is never violated, or to find an execution that violates the assertion.

Single-Procedure Programs and May-Must Analysis

A program P has a finite set of variables Vp. Each of these variables takes values from an infinite domain D (such as integers or pointers). Informally, a program is specified by its variables and its control flow graph, which may contain cycles representing program loops. Each edge of the control flow graph maps to a statement. Initially, only two types of statements are considered: assignments and assume statements. Procedure calls and returns, also are considered with respect for multi-procedure programs.

Formally, a sequential program P is defined as a 6-tuple. [symbol] Vp, Np, Ėp, nₚ⁰, ñₚ^{x}, λp [symbol] where

1. Vp is a finite set of variables that the program manipulates (each variable takes values from an infinite domain D),

2. Np is a finite set of nodes (or program locations),

3. Ep [symbol] Np×Np is a finite set of edges,

4. nₚ⁰∈Np is a distinguished entry node,

5. nₚ^{x}∈Np is a distinguished exit node,

6. λp:Ep→Stmts maps each edge with a statement in the program,

Two types of statements are considered: (1) assignment statements are of the form x :=e where x is a variable and e is a side-effect free expression over variables and constants, and (2) assume (or conditional) statements are of the form assume(e), where e is a side-effect free expression.

A configuration of a program P is a pair [symbol] n, σ [symbol] where n∈Np and σ is a state, defined below. A state of a program P is a valuation to the program variables Vp. The set of all states of P is denoted by Σp.

An assignment statement is a function Σp→Σp as it maps every state σ to a state obtained by executing the assignment. An assume statement assume (e) is a partial function over Σp. If e evaluates to true in a state s, then the function maps σ to itself. Otherwise, it is undefined over σ.

Thus, every edge ε∈Ep can be thought of as a relation Γₑ [symbol] Σp×Σp. So far, Γₑ is actually a partial function, but it is convenient to think of it as a relation, especially when considering multi-procedure programs.

Note that though each statement of the program is deterministic (i.e, Γₑ is a partial function), the program P has control non-determinism, as nodes in Np can have multiple outgoing edges in Ep.

The initial configurations of a program P may be given by the set { [symbol] nₚ⁰, σ [symbol] |σ∈Σp} That is, the node nₚ⁰ is the entry node of the program, and the state s is any possible state where variables can take any values. From any configuration. [symbol] n, σ [symbol] the program can execute a step by taking any outgoing edge of e= [symbol] n, n′ [symbol] out of n and transitioning to a state obtained by computing the image of the relation Γₑ with respect to the state σ. That is, if there exists σ′ such that Γₑ(σ, σ′), then the program can transition to the configuration [symbol] n′, σ′ [symbol] . Starting from an initial configuration, a program can execute several steps producing several configurations.

A verification question for program P is formalized as a reach-ability query of the form

$$〈 {ϕ}_{1} {{}^{?}}_{𝒫} {ϕ}_{2} 〉 ,$$

where φ₁ represents a set of initial states at entry node nₚ⁰, and φ₂ represents a set of states at an exit node nₚ^{x}. The reach-ability query evaluates to “yes” (meaning the program is incorrect) if there exists an execution which starts at a configuration [symbol] nₚ⁰, σ₁ [symbol] with σ₁∈φ₁ and ends at a configuration [symbol] nₚ^{x}, σ₂ [symbol] with σ₂∈φ₂, it evaluates to “no” if such an execution provably does not exist, or it evaluates to “unknown” otherwise. Indeed, the verification question is un-decidable in general, particularly if the domain D of values taken by variables is infinite. Even if D is finite, the number of configurations is exponential in the number of variables VP making an exact answer to this question computationally difficult to ascertain. Thus, in practice, approximate methods are used to answer the verification question.

Note that specifications in the style of Hoare triples such as {φ₁} P {φ₂}, where it is desired that all executions start from states in φ₁ end in states from φ₂, can be expressed as the query

$$〈 {ϕ}_{1} {{}^{?}}_{𝒫} {ϕ}_{2} 〉 .$$

Assertions in the form used in the example programs described later may also be expressed in this form by adding a special boolean variable error which is set to false initially and set to true if an assertion fails, enabling the statement of an equivalent specification.

$$〈 {Σ}_{𝒫} {}^{?} {}_{𝒫} error 〉 .$$

Recall that the formal definitions of weakest precondition WP and strongest post-condition SP that will be used later. Suppose Γₑ [symbol] Σp×Σp, and φ [symbol] Σp. The weakest precondition of . with respect to Γₑ (denoted WP(Γₑ, φ) is the set {σ∈Σp|∀σ′∈Σp,Γₑ(σ, σ′) [symbol] σ′∈φ}

In a dual way, the strongest post-condition of φ with respect to Γₑ (denoted SP(Γₑ, φ)) is the set {σ∈Σp|∃σ′∈φ, Γₑ(σ′, σ)}. WP and SP are dual in the following sense: for any state predicates φ₁ and φ₂, SP(Γₑ, φ₁) [symbol] φ₂ is satisfy-able iff. φ₁ [symbol] WP(Γₑ, [symbol] φ₂) is satisfy-able. Sometimes the notation Pre(Γₑ, φ) is used to denote [symbol] WP(Γₑ, [symbol] φ). If the transition relation Γₑ is deterministic (as is the case in assume and assignment statements), Pre and WP coincide. =

May Analysis

A may analysis of a program is used to prove that the program never reaches an error node during any execution. Formally, a may analysis of a program P associates every node n in Np with a finite partition Πₙ of Σp and every edge e= [symbol] n₁, n₂ [symbol] ∈Ep with a set of edges Πₑ [symbol] Πₙ_{₁}×Πₙ_{₂}, such that, for any region π₁ in Πₙ_{₁}, and any region π₂ in. Πₙ_{₂}, if ∃σ₁∈π₁, ∃σ₂∈π₂, Γₑ(σ₁, σ₂) then [symbol] π₁, π₂ [symbol] ∈Πₑ.

By construction, the edges Πₑ over-approximate the transition relation of the program, and are called may edges or transitions. A partition Πₙ for a node n is defined as a set of regions. Associated with every program edge e= [symbol] n₁, n₂ [symbol] , initially there is a may edge from every region of the partition Πₙ_{₁} to every region of the partition Πₙ_{₂}. As the algorithm proceeds, partitions get refined and may edges get deleted. Instead of deleting edges, it may be notationally convenient to maintain the complement of may edges, called Nₑ edges below. The set of Nₑ edges grows monotonically as the algorithm proceeds.

In response to a query

$$〈 {\hat{ϕ}}_{1} {}^{?} {}_{𝒫}^{}{\hat{ϕ}}{}_{2}^{} 〉 ,$$

if there is no path through the edges Πₑ from every region φ₁ associated program's entry node nₚ⁰ such that φ₁∩φ₁≠{ } to every region φ₂ associated with the exit node nₚ^{x} such that φ₂∩φ₂≠{ }, then the may analysis proves that none of the states in φ₂ can be reached at the exit node of P by starting the program with states from φ₁. Equation 5 may give a set of declarative rules to perform a may analysis which automatically refines partitions in a demand-driven manner.

In response to a query

$$〈 {\hat{ϕ}}_{1} {}^{?} {}_{𝒫}^{}{\hat{ϕ}}{}_{2}^{} 〉 ,$$

the rule INIT-PI-NE initializes the exit node nₚ^{x} with a partition consisting of two regions φ₂ and Σp\φ₂. All other nodes are initialized to have a single partition with all possible states Σp. The current set of rules performs backward may analysis, using the WP operator. Thus, to allow maximum flexibility, the initial node is not partitioned with the precondition φ₁ from the query. The precondition φ₁ is used in the last rule VERIFIED described below. The rule also initializes an empty relation Ne associated with each program edge e. Relation Ne is the complement of e and is used to keep track of may edges that are known for sure do not exist.

$$\begin{matrix}\frac{〈 {\hat{ϕ}}_{1} {}^{?} {}_{𝒫}^{}{\hat{ϕ}}{}_{2}^{} 〉}{{Π}_{{n}_{𝒫}^{x}} := \{ {\hat{ϕ}}_{2} , {Σ}_{𝒫} \backslash {\hat{ϕ}}_{2} \} ∀ n ∈ {N}_{𝒫} \backslash \{ {n}_{𝒫}^{x} \} \cdot {Π}_{n} := \{ {Σ}_{𝒫} \} ∀ e ∈ {E}_{𝒫} \cdot {N}_{e} := \{ \}} [ INIT \text{-} PI \text{-} NE ] & \\ \frac{{ϕ}_{1} ∈ {Π}_{{n}_{1}} {ϕ}_{2} ∈ {Π}_{{n}_{2}} e = 〈 {n}_{1} , {n}_{2} 〉 ∈ {E}_{𝒫} θ ⊇ WP ( {Γ}_{e} , {ϕ}_{2} )}{{Π}_{{n}_{1}} := ( {Π}_{{n}_{1}} \backslash \{ {ϕ}_{1} \} ) ⋃ \{ {ϕ}_{1} ⋂ θ , {ϕ}_{1} ⋂ θ \} {N}_{e} := {N}_{e} ⋃ \{ ( {ϕ}_{1} ⋂ θ , {ϕ}_{2} ) \}} [ NOTMAY \text{-} WP ] & \\ \frac{( {ϕ}_{1} , {ϕ}_{2} ) ∈ {N}_{e} {ϕ}_{1}^{′} ⊆ {ϕ}_{1}}{{N}_{e} := {N}_{e} ⋃ \{ ( {ϕ}_{1}^{′} , {ϕ}_{2} ) \}} [ IMPL \text{-} LEFT ] & \\ \frac{( {ϕ}_{1} , {ϕ}_{2} ) ∈ {N}_{e} {ϕ}_{2}^{′} ⊆ {ϕ}_{2}}{{N}_{e} := {N}_{e} ⋃ \{ ( {ϕ}_{1} , {ϕ}_{2}^{′} ) \}} [ IMPL \text{-} RIGHT ] & \\ \frac{〈 {\hat{ϕ}}_{1} {}^{?} {}_{𝒫}^{}{\hat{ϕ}}{}_{2}^{} 〉 \\ ∀ {n}_{0} , … , {n}_{k} , ∀ {ϕ}_{0} , … , {ϕ}_{k} . {n}_{0} = {n}_{𝒫}^{0} ⋀ {n}_{k} = {n}_{𝒫}^{x} ⋀ {ϕ}_{0} ∈ {Π}_{{n}_{0}} ⋀ {ϕ}_{1} ∈ {Π}_{{n}_{1}} … {ϕ}_{k} ∈ {Π}_{{n}_{k}} ⋀ {ϕ}_{0} ⋂ {\hat{ϕ}}_{1} \neq \{ \} ⋀ {ϕ}_{k} ⋂ {\hat{ϕ}}_{2} \neq \{ \} ∃ 0 \leq i \leq k - 1 \cdot e = 〈 {n}_{t} , {n}_{t + 1} 〉 ∈ {E}_{𝒫} ( {ϕ}_{t} , {ϕ}_{t + 1} ) ∈ {N}_{e}}{〈 {\hat{ϕ}}_{1} {}^{?} {}_{𝒫}^{}{\hat{ϕ}}{}_{2}^{} 〉 = no} \text{-} [ VERIFIED ] & \end{matrix}$$

Equation set 1. May analysis.

$$\begin{matrix}\frac{〈 {\hat{ϕ}}_{1} {}^{?} {}_{𝒫}^{}{\hat{ϕ}}{}_{2}^{} 〉}{{Ω}_{{n}_{𝒫}^{0}} := {\hat{ϕ}}_{1} ∀ n ∈ {N}_{𝒫} \backslash \{ {n}_{𝒫}^{0} \} \cdot {Ω}_{n} := \{ \}} [ INIT \text{-} OMEGA ] & \\ \frac{e = 〈 {n}_{1} , {n}_{2} 〉 ∈ {E}_{𝒫} θ ⊆ SP ( {Γ}_{e} , {Ω}_{{n}_{1}} )}{{Ω}_{{n}_{2}} := {Ω}_{{n}_{2}} ⋃ θ} [ MUST \text{-} SP ] & \\ \frac{〈 \hat{ϕ} {}^{?} {}_{𝒫}^{}{\hat{ϕ}}{}_{2}^{} 〉 {Ω}_{{n}_{𝒫}^{x}} ⋂ {\hat{ϕ}}_{2} \neq \{ \}}{〈 \hat{ϕ} {}^{?} {}_{𝒫}^{}{\hat{ϕ}}{}_{2}^{} 〉 = yes} [ BUGFOUND ] & \end{matrix}$$

Equation set 2: Must analysis

$$\frac{\begin{matrix}ϕ1 ∈ {Π}_{{n}_{1}} ϕ2 ∈ {Π}_{{n}_{2}} e = 〈 {n}_{1 ,} {n}_{2} 〉 ∈ Ep \\ {Ω}_{{n}_{1}} ⋂ {ϕ}_{1} \neq \{ \} {Ω}_{{n}_{2}} ⋂ {ϕ}_{2} = \{ \} θ ⊆ SP ( {Γ}_{e} , {Ω}_{{n}_{1}} ⋂ ϕ1 ) ϕ2 ⋂ θ \neq \{ \}\end{matrix}}{{Ω}_{{n}_{2}} := {Ω}_{{n}_{2}} ⋃ θ} [ MU ST \text{-} SP ]$$

$$\frac{\begin{matrix}ϕ1 ∈ {Π}_{{n}_{1}} ϕ2 ∈ {Π}_{{n}_{2}} e = 〈 {n}_{1 ,} {n}_{2} 〉 ∈ Ep \\ {Ω}_{{n}_{1}} ⋂ {ϕ}_{1} \neq \{ \} {Ω}_{{n}_{2}} ⋂ {ϕ}_{2} = \{ \} β ⊇ WP ( {Γ}_{e} , ϕ2 ) β ⋂ {Ω}_{{n}_{1}} = \{ \}\end{matrix}}{\begin{matrix}{Π}_{{n}_{1}} := ( {Π}_{{n}_{1}} \backslash \{ {ϕ}_{1} \} ) ⋃ \{ {ϕ}_{1} ⋂ β , {ϕ}_{1} ⋂ β \} \\ {N}_{e} := {N}_{e} ⋃ \{ ( {ϕ}_{1} ⋂ β , {ϕ}_{2} ) \}\end{matrix}} [ NOTMA Y \text{-} WP ]$$

Equation set 3. May-must analysis. Rules INIT-PI-NE, IMPL-LEFT, IMPL-RIGHT and VERIFIED are assumed to be included from Equation set 1, and rules INIT-OMEGA and BUGFOUND are assumed to be included from Equation set 2.

Abstract partition refinement is performed using the rule NOTMAY-WP. The rule NOTMAY-WP chooses two nodes n1 and n2, a region φ₁ in the partition Πₙ_{₁} of n, and a region φ₂ in the partition Πₙ_{₂} of n₂, and then splits φ₁ using the weakest precondition . of θ of φ₂ with respect to the transition relation on the edge ε= [symbol] n₁, n₂ [symbol] Splitting the region φ₁ in partition Πₙ_{₁} is denoted into two sub-regions φ₁∩θ and φ₁∩ [symbol] θ by. Πₙ_{₁}:=(Πₙ_{₁}\{φ₁})∪{φ₁∩θ, φ₁∩ [symbol] θ}. After the split, by construction it is known and the definition of WP that any state in the new region φ₁∩ [symbol] θ cannot possibly lead to a state in region φ₂, and the result is recorded in relation Ne accordingly. Note that a superset of the weakest precondition can be used as valid approximations to do splits. Such approximations are necessary in practice whenever WP cannot be computed precisely.

A dual rule NOTMAY-SP for splitting regions using the operator SP in the forward direction exists may be determined using the described equations.

The rules IMPL-RIGHT rule allows Ne edges of the form (φ₁, φ₂) to be maintained as the post-regions φ₂ get refined. The rules IMPL-LEFT rule allows Ne edges of the form (φ₁, φ₂) to be maintained as the pre-regions φ₁ get refined.

The VERIFIED rule says that as soon as all paths from the entry node regions that intersect with the precondition of the query φ₁ to the an exit node region that intersects with the post-condition of the query φ₂ have at least one step where the may analysis shows that the edge does not exist, then it has been verified that the answer to the query

$$〈 {\hat{ϕ}}_{1} {}^{?} p {\hat{ϕ}}_{2} 〉$$

is “no” and hence that the program is correct.

At every refinement step, the transition system defined over the partitioned regions simulates the program P. Thus, the incremental inference of relation Ne made by the may analysis is always guaranteed to be sound with respect to P. However, there is no guarantee that, if the program is correct, the refinement process will ever converge to such an answer. For finite-state programs, the process is guaranteed to terminate.

The partition splits specified in the rules of Equation set 1 are non deterministic. Specific abstraction-refinement tools may be viewed as instantiating this framework by refining regions only along abstract counterexamples that lead from the starting node to the error node.

Must Analysis

A must analysis of a program is used to prove that the program reaches a given set of states during some execution. While a may analysis over-approximates reach-ability information in order to prove the absence of errors, a must analysis under-approximates reach-ability information in order to prove the existence of execu-tion paths leading to an error. A must analysis based on successive partition refinements may be defined by dualizing the rules presented in the previous section. However, splitting must partitions is no longer guaranteed to preserve previously-computed must transitions and other techniques (such as hyper-must transitions or Cartesian abstraction) are needed to restore the monotonicity of must-partition refinement.

In this application, a specific type of must abstractions are considered which avoid the issues above. Specifically, a must analysis of a program P associates every node n in Np with a set Ωₙ of states that are all guaranteed to be reachable from the initial state of the program. The set Ωₙ of states associated with a node n increases monotonically during the must analysis and is never partitioned.

Equation set 2 gives a set of declarative rules to perform a must analysis using sets Ωₙ.

In response to a query

$$〈 {\hat{ϕ}}_{1} {}^{?} p {\hat{ϕ}}_{2} 〉 ,$$

Ωₙ_{ₚ}_{⁰} may be initialized with φ₁ and for all other nodes n, Ωₙ may be initialized to be the empty set (rule INIT-OMEGA).

The rule MUST-SP specifies how to perform a forward must-must analysis using the strongest post-condition operator SP: the strongest post-condition θ of Ωₙ_{₁} with respect to the transition relation associated with an edge e from node n₁ to node n₂ can be safely added to Ωₙ_{₂}. If the strongest post-condition SP cannot be computed precisely, any subset is a valid approximation. This formalization includes as a specific case, where complex constraints are simplified by substituting symbolic expressions with concrete values observed dynamically during testing.

A rule MUST-WP for backward must-analysis using the weakest precondition operator WP may be written as the dual of rule MUST-SP.

During the analysis of a query

$$〈 {\hat{ϕ}}_{1} {}^{?} p {\hat{ϕ}}_{2} 〉 ,$$

if Ωₙ_{ₚ}_{ₓ} ever intersects with φ₂, it may be concluded that the answer the query is “yes” (rule BUGFOUND).

May-Must Analysis

May and must analysis have complementary properties—the former is used for verification and the latter for bug finding. Equation 3 shows a set of rules that combine may and must rules in order to perform both a may and a must analysis simultaneously. The rules INIT-PI-NE, IMPL-LEFT, IMPL-RIGHT and VERIFIED may be included “as is” from Equation set 1, and rules INIT-OMEGA and BUGFOUND are included “as is” from Equation set 2, so they are not repeated here.

Some interesting rules may be MUST-SP and NOTMAY-WP. Suppose edge e= [symbol] n₁, n₂ [symbol] is such that φ₁∈Πₙ_{₁} and φ₂∈Πₙ_{₂}. Furthermore, suppose that φ₁∩Ωₙ_{₁}≠{ } and φ₂∩Ωₙ_{₂}={ }. This means that that the partition known φ₁∈Πₙ_{₁} is indeed reachable (since it intersects with the region Ωₙ_{₁}), and it is not known if φ₂∈Πₙ_{₂} is reachable (since it does not intersect with the region Ωₙ_{₂}). If a subset may be computed of the strongest post-condition θ [symbol] SP(Γₑ, φ₁∩Ωₙ_{₁}) such that θ intersects with φ₂, then Ωₙ_{₂} may be augmented with θ as specified in the rule MUST-SP. Dually, if the method computes a superset of the weakest precondition β [symbol] WPT(Γₑ, φ₂) such that β does not intersect with Ωₙ_{₁}, then the region φ₁∈Πₙ_{₁} may be split using β and it is known that region φ₂ is not reachable from region φ₁∩ [symbol] β as specified in the rule NOTMAY-WP.

These rules may be instantiated to obtain the SYNERGY and DASH algorithms known in the art. These algorithms have the specific property that, whenever one can compute precisely SP, equivalently WP, then either rule MUST-SP or rule NOTMAY-WP must be enabled, and a single call to a theorem prover to compute SP/WP is then sufficient to refine either the current must or may (respectively) program abstraction.

Multi-Procedure Programs and Compositional May-Must Analysis

In programs with multiple procedures, compositional analyses, which analyze one procedure at a time and build summaries for each procedure for possible re-use in other calling contexts, are desired for scalability. Compositional analysis may be accomplished with may abstractions, must abstractions and by combining may-must abstractions. First, the program notation may be extended to allow programs with multiple procedures.

A multi-procedure program P is a set of single-procedure pro-grams {P₀, P₁, . . . , Pₙ}. Each of the single-procedure programs follows the notation described earlier, with the following modifications. There may be global variables common to all procedures, and local variables private to each procedure (more precisely, private to each invocation of a procedure). Thus, for any single-procedure program Pi (also called procedure Pi), it may be that Pi= [symbol] Vpᵢ, Npᵢ, Epᵢ, nₚ_{ᵢ}⁰, nₚ_{ᵢ}^{x}, λpᵢ [symbol] where Vpᵢ is the disjoint union of global variables V^{G} and local variables V_{P}_{ᵢ}^{L}. Parameters and return values can be simulated using global variables. Without loss of generality, it may be assumed each procedure has a single entry node nₚ_{ᵢ}⁰ and a single exit node nₚ_{ᵢ}^{x}. For any two distinct procedures Pi and Pj, it may be assume that Nₚ_{ᵢ} and Nₚ_{ᵢ} are disjoint. Thus a node unambiguously identifies which procedure it is in.

In addition to the assignment and assume statements, the method may add a new statement call p where p is the name of the procedure being called. Procedure p₀ is the “main” procedure where the program starts executing. As before, all global variables initialize non-deterministically to any value in the initial configuration. Whenever a procedure is entered, its local variables are initialized non-deterministically. Unlike local variables, global variables get initialized only once at the beginning of execution, and can be used for communication between procedures.

The query notation may be used to specify verification questions for multi-procedure programs as well. In particular, for multi-procedure programs, it may be assumed that the query is asked in terms of the main procedure p₀ and is of the form

$$( {ϕ}_{1} {}^{?} {p}_{0} {ϕ}_{2} ) .$$

The compositional analyses solve the verification question by formulating various sub-queries to procedures that are called from p₀, and then sub-queries to procedures called by those procedures and so on. Each sub-query is defined in the context of a particular procedure, and is solved by analyzing the code of that procedure in combination with summaries for other called procedures.

The rules presented previously are presented in such a way that they can easily be extended to work with summaries. In particular, the edges Ne from equation set 1 may be used to build not-may summaries, and the sets Ωₙ from Equation set 2 may be used to build must summanes.

Given a set s [symbol] Σpᵢ∃∀^{L}ₚ,S may be used to denote the set of global states obtained by considering only the values of global variables of each state in S.

Compositional May Analysis

Equation set 4 gives the rules for compositional may analysis. The rules for intraprocedural may analysis from Equation set 1 are assumed to be included and are not repeated.

$$\begin{matrix} \frac{procedure {P}_{i} ∈ P}{{}^{may} {p}_{i} := \{ \}} [ INIT \text{-} NOTMAYSUM ] \\ \frac{\begin{matrix}ϕ1 ∈ {Π}_{{n}_{1}} ϕ2 ∈ {Π}_{{n}_{2}} e = \\ 〈 n 1 , n 2 〉 ∈ {Ep}_{i} is a call to procedure {P}_{j} \\ ( {\hat{ϕ}}_{1} , {\hat{ϕ}}_{2} ) ∈ {}^{may} {p}_{j} {ϕ}_{2} ⊆ {\hat{ϕ}}_{2} θ ⊆ {\hat{ϕ}}_{1}\end{matrix}}{\begin{matrix}{Π}_{{n}_{1}} := ( {Π}_{{n}_{1}} \backslash \{ {ϕ}_{1} \} ) ⋃ \{ {ϕ}_{1} ⋂ θ , {ϕ}_{1} ⋂ θ \} \\ {N}_{e} := {N}_{e} ⋃ \{ ( {ϕ}_{1} ⋂ θ , {ϕ}_{2} ) \}\end{matrix}} [ NOTMAY \text{-} WP \text{-} USESUMMARY ] \\ \frac{\begin{matrix}ϕ1 ∈ {Π}_{{n}_{1}} ϕ2 ∈ {Π}_{{n}_{2}} e = \\ 〈 n 1 , n 2 〉 ∈ {Ep}_{i} is a call to procedure Pj \\ ψ1 = ∃ {V}_{{P}_{i}}^{L} \cdot ϕ1ψ2 = ∃ {V}_{{P}_{i}}^{l} \cdot ϕ2\end{matrix}}{〈 ψ1 {}^{?} {p}_{j} ψ2 〉} [ MAY \text{-} CALL ] \\ \frac{\begin{matrix}〈 \hat{ϕ} 1 {}^{?} {p}_{i} \hat{ϕ} 2 〉 \\ ∀ n 0 , … , {n}_{k} . ∀ ϕ0 , … , {ϕ}_{k} . {n}_{0} = {n}_{{p}_{i}}^{0} ⋀ {n}_{k} = \\ {n}_{{p}_{i}}^{ϰ} ⋀ ϕ0 ∈ {Π}_{{n}_{0}} ⋀ ϕ1 ∈ {Π}_{{n}_{1}} … {ϕ}_{k} ∈ {Π}_{{n}_{k}} ⋀ ϕ0 ⋂ \hat{ϕ} 1 \neq \{ \} ⋀ {ϕ}_{k} ⋂ \hat{ϕ} 2 \neq \{ \} \\ ⇒ ∃ 0 \leq i \leq k - 1. e = 〈 {n}_{i} , {n}_{i + 1} 〉 ∈ Ep ⇒ ( {ϕ}_{i} , {ϕ}_{i + 1} ) ∈ {N}_{e}\end{matrix}}{{}^{may} {p}_{i} := {}^{may} {p}_{i} ⋃ ( ∃ {V}_{{p}_{i}}^{L} \cdot ϕ0 , ∃ {V}_{{p}_{i}}^{L} \cdot {ϕ}_{k} )} \\ [ CREATE \text{-} NOTMAYSUMMARY ] \\ \frac{( ϕ1 , ϕ ) ∈ {⇒}^{may} {P}_{i} ( ϕ2 , ϕ ) ∈ {⇒}^{may} {P}_{i}}{{⇒}^{may} {P}_{i} := {⇒}^{may} {P}_{i} ⋃ \{ ( ϕ1 ⋃ ϕ2 , ϕ ) \}} [ MERGE \text{-} MAYSUMMARY ] \\ \end{matrix}$$

Equation set 4 illustrates a compositional may analysis. Rules from Equation set 1 are assumed to be included, but not shown.

The rules maintain a set

$${⇒}^{may} {P}_{i}$$

of not-may summaries for each procedure Pi. The rule INIT-NOTMAYSUM initializes the set of not-may summaries of all procedures to empty sets. The rule NOTMAY-WP-USESUMMARY uses an existing not-may summary to split a region φ∈Πₙ_{₁} along the lines of the MAY-WP rule. Recall that if (φ₁, φ₂) is a not-may summary, then there is no transition from any state in φ₁ to any state in φ₂. Thus, for any subset θ of φ₁ there exists no transition from any state in θ to any state in φ₂ [symbol] φ₂. This justifies the Ne edge {(φ₁∩θ, φ₂)} in the consequent of the rule.

The rule MAY-CALL generates a query in the context of a called procedure after existentially quantifying local variables of the caller since those are not in the scope of the callee. For notational convenience, it is assumed that the partitions. Πₙ for each node n and the edges Nₙ are computed afresh for each invocation of a query. (Note that intraprocedural inference steps could themselves be summa-rized and re-used across multiple query invocations.)

The rule CREATE-NOTMAYSUMMARY is used to generate a not-may summary from Ne edges. If all paths from some region φ₀ in

$${\dot{Π}}_{{n}_{Pi}^{0}}$$

to some region φₖ in

$${\dot{Π}}_{{n}_{Pi}^{2}}$$

pass through at least one Nₑ edge, it may concluded that here are no paths from states in φ₀ to states in φₖ. Thus, a nit-may summary may be added between these two sets after quantifying out the local variables that are irrelevant to the calling context.

The rule MERGE-MAYSUMMARY allows not-may summaries to be merged. The correctness of this rule follows from the definition of may summaries. If there are no paths from states in φ₁ to states φ, and there are no paths from states in φ₂ to states in φ, it can be concludes that there are no paths from states in φ₁∪φ₂ states in φ. Merged summaries can contribute to larger sets θ. used to split regions in the NOTMAY-WP-USESUMMARY rule.

Compositional Must Analysis

The rules in Equation 5 along with the intra-procedural rules described in Equation 6 define compositional must analysis. The set of must-summaries for each procedure Pi is denoted

$${⇒}^{must} {P}_{i} .$$

This set is initialized to the empty set in the rule INIT-NOTMAYSUM, and it monotonically increases as the analysis proceeds.

$$\frac{procedure {P}_{i} ∈ P}{{⇒}^{must} {P}_{i} := \{ \}} [ INIT \text{-} MUSTSUMMARY ]$$

$$\frac{\begin{matrix}e = 〈 n 1 , n 2 〉 ∈ {Ep}_{i} is a call to proceedure Pj \\ ( ϕ 1 , ϕ2 ) ∈ {⇒}^{must} {p}_{j} {Ω}_{{n}_{1}} ⊇ {ϕ}_{1} θ ⊆ ϕ2\end{matrix}}{( {Ω}_{{n}_{2}} := {Ω}_{{n}_{2}} ⋃ θ )} [ \begin{matrix}MUST \text{-} SP \text{-} \\ USESUMMARY\end{matrix} ]$$

$$\frac{\begin{matrix}e = 〈 n 1 , n 2 〉 ∈ {Ep}_{i} is a call to proceedure Pj \\ θ = ∃ {V}_{{p}_{i}}^{L} {Ω}_{{n}_{1}}\end{matrix}}{〈 θ {}^{?} {p}_{j} Σ p 〉} [ MUST \text{-} CALL ]$$

$$\frac{〈 \hat{ϕ} 1 {}^{?} {p}_{i} \hat{ϕ} 2 〉 θ = ∃ {V}_{{p}_{i}}^{L} {Ω}_{{n}_{{p}_{i}}^{x}} θ ⋂ \hat{ϕ} 2 \neq \{ \}}{{⇒}^{must} {P}_{i} := {⇒}^{must} {P}_{i} ⋃ \{ ( \hat{ϕ} 1 , θ ) \}} [ CREATE \text{-} MUSTSUMMARY ]$$

$$\frac{( ϕ , ϕ1 ) ∈ {⇒}^{must} {p}_{i} ( ϕ , ϕ2 ) ∈ {⇒}^{must} {p}_{i}}{{⇒}^{must} {p}_{i} := {⇒}^{must} {p}_{i} ⋃ \{ ( ϕ , ϕ1 ⋃ ϕ2 ) \}} [ MERGE \text{-} MUSTSUMMARY ]$$

Equation set 5—Compositional must analysis. Rules from Equation set 2 are assumed to be included, but are not shown.

The rule MUST-SP-USESUMMARY is very similar to the rule MUST-SP in the intra-procedural must analysis. A difference here is that the node n1 is a call node, representing a call to another procedure Pj. If a suitable must summary (φ₁, φ₂) exists, the rule uses the must summary to compute an under-approximation to the strongest post-condition.

The rule MUST-CALL creates a new sub-query for a called procedure Pj, which can result in new summaries created for Pj. As in the compositional may analysis case, it may be assumed again for notational simplicity that the sets Ω₀ for each node n are computed afresh for each query.

The rule CREATE-MUSTSUMMARY creates must summaries in the context of the current query for the procedure. Suppose

$$〈 {\hat{ϕ}}_{1} {}^{?} {p}_{i} {\hat{ϕ}}_{2} 〉$$

is the current query for the procedure Pi. Suppose

$$θ = ∃ {V}_{{𝒫}_{i}}^{ℒ} \cdot {Ω}_{{n}_{{𝒫}_{i}}^{z}}$$

represents the global state reached at the exit point of the procedure Pi by using must analysis. Further suppose that θ intersects with the post-state of the query φ₂. Then, the must summary {(φ₁, θ)} may be added as every state in θ can be obtained by executing the procedure starting at some state in φ₁.

Finally the rule MERGE-MUSTSUMMARY allows merging must summaries. The correctness of this rule follows from the definition of must summaries. If every state in φ₁ can be reached from some state in φ, and every state in φ₂ may be reached from some state in φ, it follows that every state in φ₁∪φ₂ may be reached from some state in φ.

These set of rules can be instantiated to obtain a variant of the SMART algorithm, a compositional version of the DART algorithm which are known in the art. Indeed, the described rules compute summaries for specific calling contexts (see θ in rule MUST-CALL) and record those in the pre-conditions of summaries. In contrast, preconditions of summaries in SMART are expressed exclusively in terms of the procedure's in-put variables and calling contexts themselves are not recorded. The summaries of SMART may therefore be more general (hence more re-usable), while the summaries record must-reachability information more precisely, which in turns simplifies the formalization and the combination with may summaries, as is discussed next.

SMASH: Compositional May-Must Analysis

The rules for compositional may-must analysis combine the may rules and the must rules in the same way as in the single procedure case. The set of rules is shown in Equation 6. All rules from compositional may analysis (Equation set 4), compositional must analysis (Equation set 5), and intra-procedural may-must analysis (Equation set 3) are included but not shown, except the rules MAY-CALL and MUST-CALL which are replaced by the new rule MAYMUST-CALL, and except the rules MUST-SP-USESUMMARY and NOTMAY-WP-USESUMMARY which are modified as shown in Equation set 6.

$$\frac{\begin{matrix}ϕ1 ∈ {Π}_{{n}_{1}} ϕ2 ∈ {Π}_{{n}_{2}} ϕ1 ⋂ {Ω}_{{n}_{1}} \neq \{ \} ϕ2 ⋂ {Ω}_{{n}_{2}} = \{ \} \\ e = 〈 n 1 , n 2 〉 ∈ {Ep}_{i} is a call to proceedure Pj \\ ( \hat{ϕ} 1 , \hat{ϕ} 2 ) ∈ {⇒}^{must} {p}_{j} {Ω}_{{n}_{1}} ⊇ {\hat{ϕ}}_{1} θ ⊆ \hat{ϕ} 2 ϕ2 ⋂ θ \neq \{ \}\end{matrix}}{{Ω}_{{n}_{2}} := {Ω}_{{n}_{2}} ⋃ θ} [ \begin{matrix}MUST \text{-} SP \text{-} \\ USESUMMARY\end{matrix} ]$$

$$\frac{\begin{matrix}ϕ1 ∈ {Π}_{{n}_{1}} ϕ2 ∈ {Π}_{{n}_{2}} ϕ1 ⋂ {Ω}_{{n}_{1}} \neq \{ \} ϕ2 ⋂ {Ω}_{{n}_{2}} = \{ \} \\ e = 〈 n 1 , n 2 〉 ∈ {Ep}_{i} is a call to proceedure Pj \\ ( \hat{ϕ} 1 , \hat{ϕ} 2 ) ∈ {⇒}^{may} {p}_{j} ϕ2 ⊆ \hat{ϕ} 2 θ ⊆ \hat{ϕ} 1 θ ⋂ {Ω}_{{n}_{1}} = \{ \}\end{matrix}}{\begin{matrix}{Π}_{{n}_{1}} := ( {Π}_{{n}_{1}} \backslash \{ {ϕ}_{1} \} ) ⋃ \{ {ϕ}_{1} ⋂ θ , {ϕ}_{1} ⋂ θ \} \\ {N}_{e} := {N}_{e} ⋃ \{ ( {ϕ}_{1} ⋂ θ , {ϕ}_{2} ) \}\end{matrix}} [ \begin{matrix}NOTMAY \text{-} WP \text{-} \\ USESUMMARY\end{matrix} ]$$

$$\frac{\begin{matrix}ϕ1 ∈ {Π}_{{n}_{1}} ϕ2 ∈ {Π}_{{n}_{2}} ϕ1 ⋂ {Ω}_{{n}_{1}} \neq \{ \} ϕ2 ⋂ {Ω}_{{n}_{2}} = \{ \} \\ e = 〈 n 1 , n 2 〉 ∈ {Ep}_{i} is a call to proceedure Pj \\ ψ1 = ∃ {V}_{{P}_{i}}^{L} \cdot ( ϕ1 ⋂ {Ω}_{{n}_{1}} ) ψ2 = ∃ {V}_{Pi}^{L} \cdot ϕ2\end{matrix}}{〈 ψ1 {}^{?} {P}_{j} ψ2 〉} [ MAYMUST \text{-} CALL ]$$

Equation set 6. SMASH: Compositional may-must analysis. All rules from compositional may analysis (Equation set 4), compositional must analysis (Equation set 5), and intra-procedural may-must analysis (Equation set 3) are included but not shown, except the rules MAY-CALL and MUST-CALL which are replaced by the new rule MAYMUST-CALL, and except the rules MUST-SP-USESUMMARY and NOTMAY-WP-USESUMMARY which are modified as shown above.

The succinctness of these rules hides how may summaries and must summaries interact, it is described in more detail. Each query made to SMASH may be answered with either a not-may summary or a must summary, but not both. Whenever SMASH analyzes a procedure Pi and encounters an edge e in Pi calling another procedure Pj, SMASH may either use an existing must summary for procedure Pj (using the rule MUST-SP-USESUMMARY), or an existing not-may summary for Pj (using the rule NOTMAY-WP-USESUMMARY), or initiate a fresh query to Pj (using the rule MAY-MUST-CALL). Note that when the rule MAY-MUST-CALL generates a query for the called procedure Pj, it is not known if the query will result on creating not-may summaries or must summaries. If the body of Pj calls another procedure Pk, another query may be potentially generated for that procedure as well. Eventually, some of the calls could be handled using must summaries (using the rule NOTMAY-WP-USESUMMARY), and some of the calls using not-may summaries (using the rule NOTMAY-WP-USESUMMARY). Thus, not-may summaries can be used to create must summaries and vice versa.

The rule MUST-SP-USESUMMARY is similar to the rule MUST-SP in Equation set 7. The main difference is that the edge e is a call to another procedure Pj. Assuming a suitable must summary exists, the rule uses the must summary as the transition relation of the procedure call in order to perform the equivalent of a SP computation. Suppose edge e= [symbol] n₁, n₂ [symbol] is such that φ₁∈Πₙ_{₁} and φ₂∈Πₙ_{₂}. Furthermore, suppose that φ₁∩Ωₙ_{₁}≠{ }, φ₂∩Ωₙ_{₂}={ } and (φ₁, φ₂) is a must-summary for Pj, with Ωₙ_{₁} [symbol] φ₁. Since (φ₁, φ₂) is a must-summary, it is known that all the states in φ₂ are reachable by executions of Pj from states in φ₁. Since Ωₙ_{₁} [symbol] φ₁, this implies that any subset θ [symbol] φ₂ can be reached from the set of sates Ωₙ_{₁} by executing the procedure Pj. Thus, θ may be added to the set of states Ωₙ_{₂}, which are the set of states that are guaranteed to be reachable at node n₂ during this execution of procedure Pj.

Similarly, the rule NOTMAY-WP-USESUMMARY is like the rule NOTMAY-WP in Equation set 3. The main difference is again that the edge e is a call to another procedure Pj. Assuming a suitable may summary exists, the rule uses the may summary as the transi-tion relation of the procedure call to perform the equivalent of a WP computation. Suppose e,φ₁ and φ₂ satisfy the same assumptions as above, and there is a not-may summary (φ₁, φ₂) with φ₂ [symbol] φ₂. Since (φ₁, φ₂) is a not-may summary, it is known that there are no executions of the procedure Pj starting at any subset θ [symbol] φ₁ resulting in states in φ₂. Thus, the region φ₁∈Πₙ_{₁} may be partitioned with the guarantee that there are no transitions from φ₁∩θ to φ₂, and hence (φ₁∩θ, φ₂) may be added to Ne.

Given e, φ₁, φ₂, Ωₙ_{₁}, it can shown that both rules MUST-SP-SUMMARY and NOTMAY-WP-USESUMMARY may never be simultaneously enabled since, by construction, it not possible to both have a must summary (φ₁, φ₂) and a not-may summary (ψ₁, ψ₂) for a procedure such that ψ₁ [symbol] φ₁ and ψ₂ [symbol] φ₂.

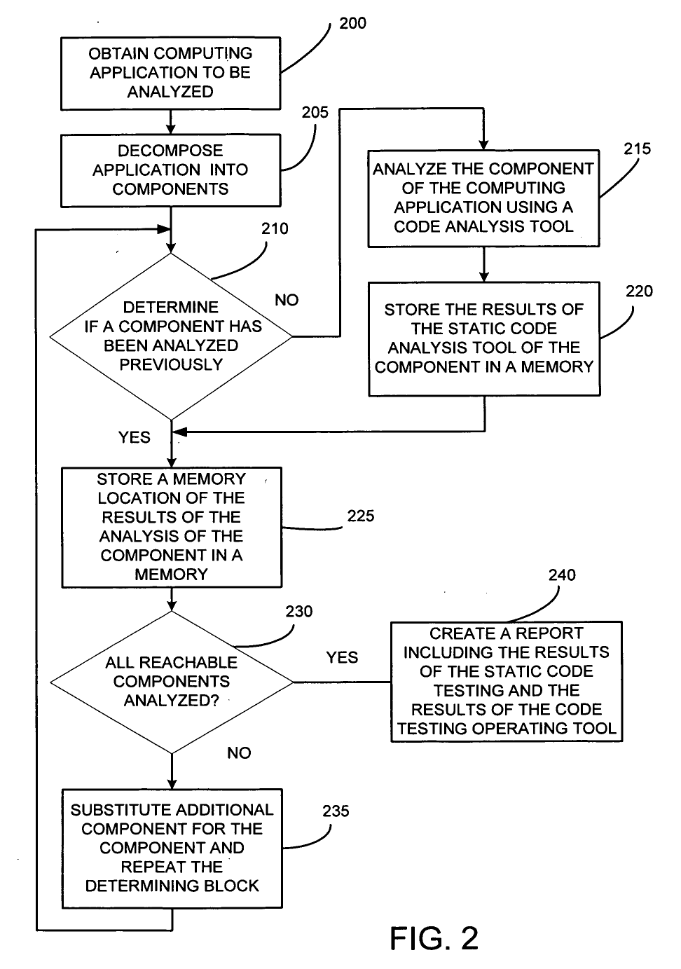

FIG. 2 may illustrate a method of checking code for errors in accordance with the claims. At block 200, a computing application to be analyzed may be obtained. The application may be an application, including extremely complex and lengthy applications. The method is not constrained by complexity or length.

At block 205, the application may be decomposed into a plurality of components of the computing application. The decomposition may include identifying discrete procedures in the application and analyzing the procedures as components. In another embodiment, the decomposition may included analyzing procedure(s) as components. In yet another embodiment, decomposing the application into a plurality of components of the computing application may include determining components that can be reached from a plurality of starting points. The starting points may be picked logically or usage patterns may be studied and starting points may be selected based on usage.

At block 210, it may be determined if a component has been analyzed previously. If the component has been reviewed previously, it may not need to be reviewed again which would be more efficient. In one embodiment, a database may be reviewed to see if the component has been indicated as being analyzed previously in the database. For example, a summary of a previous analysis may be stored in the database on the component in question. In some embodiments, it may be determined if a may answer exists for the component. In another embodiment, it may be determined if a must answer exists for the component previously. In further embodiments, the analysis may determine if the previous analysis is acceptable. For example, it may be determined whether the analysis was performed on the same version of the code, if the analysis was performed using the most recent code version, if the analysis was performed using an acceptable analysis tool, etc.

At block 215, if the component from the plurality of components has not been analyzed previously, the component of the computing application may be analyzed using a code analysis tool. The code tool could be a static tool or a code testing tool. The error may take on virtually any form. In some embodiments, the static code tool can provide false positives which require further analysis which may occur using the code testing tool. The code testing operating tool uses actual tests of the code to see if errors occur given a set of inputs. In one embodiment, components that can be reached from a given starting point will be analyzed and components that cannot be reached from a given starting point will not be analyzed. Again, in this way, only code sections that can actually be reached from a given starting point or given procedure will be analyzed, further promoting efficiency.

At block 220, the results of the code analysis tool of the component may be stored in a memory that may be accessed by additional components or future analysis of the components. As mentioned previously, the memory may be a database or any other structured memory that can be efficiently used to provide access to the relevant data such the components will not be repeatedly analyzed, but analyzed once.

At block 225, if the component from the plurality of components has been analyzed previously, a memory location of the results of the analysis of the component in a memory may be stored. In one embodiment, storing a memory location of the results of the analysis of the component in a memory may entail storing the location in the database in a memory. In another embodiment, the memory location may be a physical memory address. Of course, other ways of keeping track of previously undertaken analyses are possible and are contemplated.

At block 230, it may be determined whether all reachable components have been analyzed. In this way, all possible components will be analyzed (determining reachable components) and effort will not be wasted analyzing components that cannot be reached. A may analysis or static analysis may be one way to determine the components that may be reached. The method may track the components and ensure each is analyzed. If all the components have not been analyzed, control may pass to block 235 where an additional component may be analyzed. If all the components have been analyzed, control may pass to block 240.

At block 240, a report may be created that includes the results of the static code testing and the results of the results of the code testing operating tool. The results may be a listing of errors and responsible code sections. In another embodiment, the report will include suggestions on how to address the error. In yet another embodiment, the report may list other relevant information about the error such as how often the component is accessed, where access originates, what specific values cause errors, etc.

### EXAMPLES

### Example 1

Consider the example in code set 1

| | |
|---|---|
| void main(int i1,i2,i3) | int g(int i) |
| { | { |
| 0: int x1,x2,x3; | 11: if (i > 0) |
| 1: x1 = g(i1); | 12: return i; |
| 2: x2 = g(i2); | 13: else |
| 3: x3 = g(i3); | 14: return −i; |
| 4: if ((x1 < 0)\|\|(x2 < 0)\|\|(x3 < 0)) | } |
| 5: assert(false); | |
| } | |

Code set 1. Example to illustrate benefits of may summaries.

The inputs of this program are the arguments passed to the function main. Since function g always returns non-negative values, the assertion at line 5 of function main can never be reached. This can be proved using a not-may summary for the function g. Given the assertion in line 5 of function main as a goal, SMASH first tries to find an execution along the path 1, 2,3,4,5. After some analysis, SMASH generates the query

$$( true {{}^{?}}_{g} ( retval < 0 ) ) .$$

Since all paths in g result in a return value greater than or equal to 0, this result is encoded as a not-may summary.

$$( true {{⇒}^{may}}_{g} ( retval < 0 ) ) .$$

Once this not-may summary is computed, it may be used at all the call-sites of g in function main (at lines 1,2 and 3) to show that the assertion failure in line 5 can never be reached.

| void main(int i1,i2,i3) | | int f(int i) | |
|---|---|---|---|
| { | | { | |
| int x1,x2,x3; | | 11: if (i > 0) | |
| 1: | x1 = f(i1); | 12: | return i; |

| | | |
|---|---|---|
| 2: | x2 = f(i2); | else |

| | | | |
|---|---|---|---|
| 3: | x3 = f(i3); | 13: | return h(i); |

| | | |
|---|---|---|
| 4: | if (x1 > 0) | //h(i) is a complex function |

| | | |
|---|---|---|
| 5: | if (x2 > 0) | //such as a hash function |

| | | |
|---|---|---|
| 6: | if(x3>0) | } |

| | |
|---|---|
| 7: | assert(false); } |

Code set 2. Example to illustrate benefits of must summaries.

### Example 2

Consider the example program in Code set 2. Function f has two branches, one of which (the else branch) is hard to analyze since it invokes a complicated or even unknown hash function h. As before, SMASH first tries to find an execution along the path 1, 2,3,4,5,6,7. From the conditions in lines 4, 5 and 6, it incrementally collects the constraints x1>0, x2>0, and x3>0, and generates a query

$$〈 true {{}_{f}}^{?} ( retval > 0 ) 〉$$

for function f where retval denotes the return value of that function. SMASH now searches for an execution path in f that satisfies the postcondition (retval>0) and computes the must summary

$$〈 ( i > 0 ) {{⇒}_{f}}^{must} ( retval > 0 ) 〉$$

by exploring only the “if” branch of the conditional at line 11 and avoiding the exploration of the complex function h in the “else” branch. Once this must summary is computed for f, a symbolic execution along the path 1, 2, 3, 4,5,6,7 can reuse this summary (as in SMART [13, 1]) at the call sites at lines 1,2 and 3 without descending into f any further. Next, SMASH generates a test input for main satisfying the constraints i1>0λi2>0 [symbol] i3>0 to prove that the assertion violation in line 7 can be reached.

Next, the interplay may be illustrated between may summaries and must summaries using simple examples.

| | |
|---|---|
| void main(int j) | int foo(int i,j) |
| { | { |
| 1:int i=0; | 11:if(j>0) |
| 2: x = foo(i,j); | 12: return bar(i)+1; |
| 3: if (x == 1) | 13: else |
| 4: assert(false); | 14: return i+1; }} |

Code set 3. Example of must summary benefiting from may summary.

### Example 3

Consider the example in Code set 3. In this example, suppose bar is a complex function with nested function calls and a large number of paths, but one which already has a not-may summary

$$〈 ( i = 0 ) {{⇒}^{may}}_{bar} ( retval = 0 ) 〉 .$$

The may summary can help with computing a must summary of foo.

During the analysis of main, SMASH tries to generate an execution that goes along the path 1, 2, 3, 4 in function main. This results in the query.

$$〈 ( i = 0 ) {{}^{?}}_{foo} ( retval = 1 ) 〉 .$$

This query results in SMASH searching through paths in foo for an execution satisfying the query. However, due to the not-may summary

$$〈 ( i = 0 ) {{⇒}^{may}}_{bar} ( retval = 0 ) 〉 ,$$

SMASH is immediately able to conclude that none of the paths through bar can result in the desired post-condition (retval=1) for foo given that i=0. Thus, it explores only the “else” branch of the if statement in line 11 and generates the must summary

$$〈 ( i = 0 j \leq 0 ) {{⇒}^{must}}_{foo} ( retval = 1 ) 〉 .$$

Note that while computing such a must summary, the SMASH algorithm uses the not-may summary of bar to conclude that no path through bar would result in the desired post condition, hence avoiding a wasteful search through the large number of paths in bar. Once the must summary for.

$$〈 ( i = 0 j \leq 0 ) {{⇒}^{must}}_{foo} ( retval = 1 ) 〉$$

is computed, SMASH uses it to analyze main and establish that any test case j=0 violates the assertion in line 4.

### Example 4.

Consider the example in Code set 4.

| void main(int i,j) | int foo(int i,j) | |
|---|---|---|
| { | { | |
| 0: int x; | 10: int r,y; | |
| 1:if(i>0&&j>0){ | 11:r=0; | |
| 2: x = foo(i,j); | 12: y = bar(i); | |
| 3: if(x<0) | | 13:if(y>0) |
| 4: assert(false); | 14: | r = g(j); |

| | |
|---|---|
| } | 16: return r; |
| } | } |
| int g(int k) | |
| { | |
| 20: if (k > 0) | |
| 21: return k; | |
| 22: else | |
| 23: return −k; | |
| } | |

Code set 4. Example of may summary benefiting from must summary.

In this example, suppose bar is a complex function with loops and complex loop-invariants such that a may-analysis of bar would not converge, yet with a known must summary

$$〈 ( i > 5 ) {{⇒}^{must}}_{bar} ( retval > 5 ) 〉$$

obtained by symbolically executing a particular path in bar. It will be illustrated how this must summary can help with computing a may summary for foo to prove that the assertion in line 4 of main can never be reached.

SMASH first tries to find an execution along the path 1, 2, 3, 4 in main. For this purpose, it generates the query

$$〈 ( i > 0 j > 0 ) {{}^{?}}_{foo} ( retval < 0 ) 〉 .$$

During the analysis of foo, SMASH uses the must summary.

$$〈 ( i > 5 ) {{⇒}^{must}}_{bar} ( retval > 5 ) 〉 .$$

to get a symbolic execution up to line 14. Then, it generates the query

$$〈 ( j > 0 ) {{}^{?}}_{g} ( retval < 0 ) 〉 .$$

While analyzing the body of g with precondition j>0, SMASH concludes that the return value retval is always greater than 0. Thus, it generates the not-may summary

$$〈 ( j > 0 ) {{⇒}^{may}}_{g} ( retval \leq 0 ) 〉 .$$

This results in the generation of the not-may summary.

$$〈 ( i > 0 j > 0 ) {{⇒}^{may}}_{foo} ( retval < 0 ) 〉$$

in response to the query

$$〈 ( i > 0 j > 0 ) {{}^{l}}_{foo} ( retval < 0 ) 〉 .$$

Using this not-may summary, SMASH can prove that the assertion in line 6 of main can never be reached. Again, observe how SMASH is able to use a must summary of bar together with a not-may summary of g to generate a suitable not-may summary for foo, thus avoiding a may analysis of bar.

Even though these examples are simple, they illustrate common patterns exhibited in large programs. Some parts of large programs are more amenable to may analysis while some parts are more amenable to must analysis. In particular, for functions with many paths due to nested calls, conditionals and loops, but simple post-conditions established in post-dominator of all paths (such as the last statement before return), not-may summaries can be easy to compute. Such not-may summaries can be used to avoid an expensive search of (possibly infinitely many) explicit paths during must analysis, as seen in Example 3. On the other hand, if a function has complex loops with complex loop invariants, a may analysis tends not to converge, while a must analysis of the same code can easily identify be a few feasible paths that traverse entirely the function and generate usable must summaries for those paths. Such must summaries can be used to avoid an expensive search for proofs in these parts of the code, as illustrated in Example 4—the tight integration between may and must summaries allows SMASH to freely alternate between both in a flexible and unprecedented manner.

In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of checking computer code for errors comprising:
obtaining a computing application to be analyzed;
decomposing the computing application into a plurality of components of the computing application;
determining if an analysis of a component of the plurality of components has been completed previously;
if the analysis of the component from the plurality of components has been completed previously,
storing a memory location of results of the analysis of the component in a memory;
substituting an additional component for the component and repeating the determining if the analysis of the component has been completed previously block;
analyzing the component of the computing application using a code analysis tool wherein the code analysis tool is selected from a group comprising a static analysis tool and a code testing operating tool;
storing the results of the code analysis tool of the component in an additional memory that may be accessed by additional components; and
creating a report that includes the results of the code analysis tool.

2. The method of claim 1, wherein decomposing the computing application comprises identifying discrete procedures in the computing application and analyzing each procedure as the component.

3. The method of claim 1, wherein determining if the component has been analyzed previously comprises reviewing a database to see if the component has been indicated as being analyzed previously in the database.

4. The method of claim 3, wherein storing the memory location of the results of the analysis of the component in an additional memory further comprises storing a location in the database.

5. The method of claim 1, further comprising
analyzing the component of the computing application using the code testing operating tool;
if the code testing operating tool locates the error,
analyzing the component of the computing application using the static code analysis tool; and
storing the results of the static code analysis tool of the component in an additional memory that may be accessed by a future analysis.

6. The method of claim 1, further comprising analyzing bounded procedure as the component.

7. The method of claim 1, wherein decomposing the computing application into the plurality of components of the computing application further comprises determining reachable components wherein reachable components are components that can be reached from a plurality of starting points.

8. The method of claim 7, further comprising analyzing the reachable components from a given starting point.

9. The method of claim 7, further comprising not analyzing the components that cannot be reached from a given starting point.

10. A computing system for checking computer code for errors comprising a processor physically configured in accordance with computer executable instructions, a memory physically configured according to computer executable instructions and an input/output circuit, the computer executable code comprising code for:
obtaining a computing application to be analyzed;
decomposing the computing application into a plurality of components of the computing application;
determining if an analysis of a component of the plurality of components has been completed previously;
if the analysis of the component from the plurality of components has been completed previously,
storing a memory location of results of the analysis of the component in a memory;
substituting an additional component for the component and repeating the determining if the analysis of the component has been completed previously block;
analyzing the component of the computing application using a code analysis tool wherein the code analysis tool is selected from a group comprising a static analysis tool and a code testing operating tool;
storing the results of the code analysis tool of the component in an additional memory that may be accessed by additional components; and
creating a report that includes the results of the code analysis tool.

11. The computer system of claim 10, wherein decomposing the computing application comprises identifying discrete procedures in the computing application and analyzing each procedure as the component.

12. The computer system of claim 10, wherein determining if the component has been analyzed previously comprises reviewing a database to see if the component has been indicated as being analyzed previously in the database.

13. The computer system of claim 10, wherein storing the memory location of the results of the analysis of the component in an additional memory further comprises storing a location in the database.

14. The computer system of claim 10, further comprising
analyzing the component of the computing application using the code testing operating tool;
if the code testing operating tool locates the error,
analyzing the component of the computing application using the static code analysis tool; and
storing the results of the static code analysis tool of the component in an additional memory that may be accessed by a future analysis.

15. The computer system of claim 10, further comprising analyzing bounded procedure as the component.

16. The computer system of claim 10, wherein decomposing the computing application into the plurality of components of the computing application further comprises determining reachable components wherein reachable components are components that can be reached from a plurality of starting points.

17. The computer system of claim 10, further comprising analyzing the reachable components from a given starting point.

18. The computer system of claim 10, further comprising not analyzing the components that cannot be reached from a given starting point.
